(19) United States
(12) Patent Application Publication
(10) Pub. No.: US 2015/0333659 A1
(43) Pub. Date: Nov. 19, 2015

(54) CIRCUIT ARRANGEMENT

(71) Applicant: Semikron Elektronik GmbH & Co., KG, Nurnberg (DE)

(72) Inventor: Kevork HADDAD, Hollis, NH (US)

(21) Appl. No.: 14/714,321

(22) Filed: May 17, 2015

Related U.S. Application Data
(60) Provisional application No. 61/994,730, filed on May 16, 2014.

(51) Int. Cl. H02M 7/537

(52) U.S. Cl. CPC H02M 7/537

(57) ABSTRACT

A circuit arrangement for a multilevel power converter comprising a first and second circuit branches, electrically connected in parallel. The arrangement further comprises a positive, negative and neutral potential voltage connections, and first and second AC voltage connections. First circuit branch has controllable first, second and sixth electrical valves and third, fourth and fifth diodes. Second circuit branch has controllable third, fourth and fifth electrical valves and first, second and sixth diodes. In the invention, a power semiconductor switch is connected back-to-back in parallel with a diode provided in a conventional manner in first current branch so that sixth electrical valve is formed, and a power semiconductor switch is connected back-to-back in parallel with a diode provided in a conventional manner in second current branch so that fifth electrical valve is formed. The inventive circuit arrangement has reduced power losses.

### BACKGROUND OF THE INVENTION

1. Field of the Invention

The invention is directed to a circuit arrangement for a multilevel power converter.

2. Description of the Related Art

A multilevel power converter differs from conventional power converters currently in widespread use by the fact that, when it is operated as an inverter, it can not only generate an electrical AC voltage whose voltage value substantially corresponds to the positive or negative electric voltage of the DC− link voltage Ud, at its connections on the AC voltage side, as can a conventional power converter, but can additionally generate electric voltages whose voltage value in particular corresponds to, for example, half the positive or negative electric voltage of the DC− link voltage Ud or, generally depending on the specific design of the multilevel power converter, to an N component (where N≧2) of the positive or negative electric voltage of the DC− link voltage Ud, at the connections on the AC voltage side.

As a result, the voltages generated by the power converter at the connection on the AC voltage side can be brought closer to a sinusoidal AC voltage, for example.

A multilevel power converter in this case has a plurality of circuit arrangements, which are electrically interconnected to one another to realize a multilevel power converter.

FIG. 1 shows a circuit arrangement 1a known from WO 2009/132427 A1. FIG. 2 shows a switching state table, in which the voltage U of circuit arrangement 1a which occurs between first and second AC voltage connections AC1 and AC2 is illustrated as a function of the switching states Sz of controllable power converter valves T1 to T4. In this case, a “0” means that the power converter valve in question is switched off and a “1” means that the power converter valve in question is switched on. The electrical load LA may be, for example, a winding of a three-phase reluctance motor, wherein a circuit arrangement 1a assigned to the respective winding is provided for each of the three windings of the three-phase reluctance motor. The three circuit arrangements 1a together form a multilevel power converter, more precisely a three-phase multilevel power converter. The circuit arrangements 1a in this case each have first and second current branches 2a and 3a.

Circuit arrangement 1a is fed by two voltage sources (not illustrated in FIG. 1), which each generate half the DC− link voltage Ud/2, so that the DC− link voltage Ud is present between the positive potential voltage connection DC+ and the negative potential voltage connection DC−. Neutral connection of circuit arrangement 1a is denoted by N in FIG. 1. If circuit arrangement 1a is in switching state 1, for example, the load current I flows from neutral connection N via the fifth diode D5 and via the second electrical valve T2 to the load LA and from the load LA via the second and first diodes D2 and D1 to the positive potential voltage connection DC+. If circuit arrangement 1a is in switching state 3, for example, the load current I flows from the negative potential voltage connection DC− via the fourth and third diodes D4 and D3 to the load LA and from the load LA via the third electrical valve T3 and via the sixth diode D6 to neutral connection N.

### SUMMARY OF THE INVENTION

It is an object of the invention is to provide an improved circuit arrangement for a multilevel power converter which has reduced power losses, and a circuit system employing such circuit arrangements.

This object is achieved by a circuit arrangement comprising first and second circuit branches, with the second circuit branch being connected electrically in parallel with the first circuit branch. The circuit arrangement further comprises a positive potential voltage connection, a negative potential voltage connection, a neutral connection and first and second AC voltage connections, wherein the first circuit branch has a controllable first, second and sixth electrical valve and a third, fourth and fifth diode, wherein the second circuit branch has a controllable third, fourth and fifth electrical valve and a first, second and sixth diode, wherein the first load current connection of the first electrical valve is electrically conductively connected to the cathode of the first diode and to the positive potential voltage connection, wherein the second load current connection of the fourth electrical valve is electrically conductively connected to the anode of the fourth diode and to the negative potential voltage connection, wherein the second load current connection of the first electrical valve is electrically conductively connected to the first load current connection of the second electrical valve and the cathode of the fifth diode, wherein the anode of the first diode is electrically conductively connected to the first load current connection of the fifth electrical valve and the cathode of the second diode, wherein the anode of the fifth diode is electrically conductively connected to the neutral connection and to the first load current connection of the sixth electrical valve, wherein the anode of the second diode is electrically conductively connected to the second AC voltage connection and to the first load current connection of the third electrical valve, wherein the second load current connection of the second electrical valve is electrically conductively connected to the cathode of the third diode and to the first AC voltage connection, wherein the second load current connection of the fifth electrical valve is electrically conductively connected to the cathode of the sixth diode and to the neutral connection, wherein the second load current connection of the sixth electrical valve is electrically conductively connected to the anode of the third diode and to the cathode of the fourth diode, wherein the second load current connection of the third electrical valve is electrically conductively connected to the anode of the sixth diode and to the first load current connection of the fourth electrical valve.

It has proven to be advantageous if the first circuit branch has a controllable seventh electrical valve and a seventh diode, and the second circuit branch has a controllable eighth electrical valve and an eighth diode, wherein the first load current connection of the seventh electrical valve is electrically conductively connected to the anode of the fifth diode, and the second load current connection of the seventh electrical valve is electrically conductively connected to the anode of the seventh diode, and the cathode of the seventh diode is electrically conductively connected to the second load current connection of the second electrical valve or the first load current connection of the seventh electrical valve is electrically conductively connected to the cathode of the seventh diode and the second load current connection of the seventh electrical valve is electrically conductively connected to the second load current connection of the second electrical valve and the anode of the seventh diode is electrically conductively connected to the anode of the fifth diode,
wherein the first load current connection of the eighth electrical valve is electrically conductively connected to the anode of the second diode, and the second load current connection of the eighth electrical valve is electrically conductively connected to the anode of the eighth diode, and the cathode of the eighth diode is electrically conductively connected to the second load current connection of the fifth electrical valve or the first load current connection of the eighth electrical valve is electrically conductively connected to the cathode of the eighth diode and the second load current connection of the eighth electrical valve is electrically conductively connected to the second load current connection of the fifth electrical valve and the anode of the eighth diode is electrically conductively connected to the anode of the second diode.

As a result, the power losses of the circuit arrangement can be further reduced.

Furthermore, it has proven to be advantageous if the circuit arrangement has first and second inductances and a total AC voltage connection, wherein the first inductance is connected electrically between the first AC voltage connection and the total AC voltage connection, wherein the second inductance is electrically connected between the second AC voltage connection and the total AC voltage connection. The circuit arrangement can thus form one phase of a polyphase multilevel power converter.

In addition, it has proven to be advantageous if the first and second inductances are coupled magnetically to one another. As a result, optimum matching of the circuit arrangement to the specific application is possible.

Furthermore, a circuit system comprising first and second circuit arrangements according to the invention and further comprising first, second, third and fourth inductances and comprising a total AC voltage connection has proven to be advantageous, wherein the positive potential voltage connection of the first circuit arrangement is electrically conductively connected to the positive potential voltage connection of the second circuit arrangement, and the negative potential voltage connection of the first circuit arrangement is electrically conductively connected to the negative potential voltage connection of the second circuit arrangement, wherein the first inductance is connected electrically between the first AC voltage connection of the first circuit arrangement and the total AC voltage connection, wherein the third inductance is connected electrically between the first AC voltage connection of the second circuit arrangement and the total AC voltage connection, wherein the second inductance is connected electrically between the second AC voltage connection of the first circuit arrangement and the total AC voltage connection, wherein the fourth inductance is connected electrically between the second AC voltage connection of the second circuit arrangement and the total AC voltage connection, wherein the neutral connection of the first circuit arrangement is electrically conductively connected to the neutral connection of the second circuit arrangement, wherein the first and third inductances are coupled magnetically to one another, and the second and fourth inductances are coupled magnetically to one another. The circuit system can therefore have a very high electric power, which can be matched to the specific requirements by interconnection of as many circuit arrangements as required in a simple manner.

Other objects and features of the present invention will become apparent from the following detailed description of the presently preferred embodiments, considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows an electrical circuit diagram of a circuit arrangement which is conventional in the art;

FIG. 2 shows a switching state table of the power converter valves of the circuit arrangement which is conventional in the art;

FIG. 3 shows an electrical circuit diagram of a circuit arrangement according to the invention;

FIG. 4 shows a switching state table of the power converter valves of the circuit arrangement according to the invention;

FIG. 5 shows an electrical circuit diagram of a further circuit arrangement according to the invention;

FIG. 6 shows an electrical circuit diagram of a further circuit arrangement according to the invention;

FIG. 7 shows an electrical circuit diagram of a further circuit arrangement according to the invention; and

FIG. 8 shows an electrical circuit diagram of a circuit system comprising a first and a second circuit arrangement according to the invention.

### DETAILED DESCRIPTION OF THE PRESENTLY PREFERRED EMBODIMENTS

It will be mentioned at this juncture that, within the meaning of the invention, a “controllable electrical valve” is understood to mean a power semiconductor switch with a diode connected back-to-back in parallel. The power semiconductor switch is generally in the form of a transistor, such as, for example, an IGBT (insulated-gate bipolar transistor) or a MOSFET (metal-oxide semiconductor field-effect transistor) or in the form of thyristors which can be switched off in a controlled manner, wherein, within the scope of the exemplary embodiment, the power semiconductor switches are in the form of IGBTs and first load current connection C of the respective power semiconductor switch is in the form of the collector of the respective IGBT, and second load current connection E of the respective power semiconductor switch is in the form of the emitter of the respective IGBT. If the power semiconductor switch is in the form of a MOSFET, the diode connected back-to-back in parallel is generally an integral component of the MOSFET and is not present as a discrete component. A MOSFET therefore already represents a controllable electrical valve within the meaning of the invention.

The switching-on and switching-off of the power semiconductor switch and therefore of the controllable electrical valve is controllable via the control connection of the power semiconductor switch (for example gate in the case of the IGBT).

In order to increase the current-carrying capacity, a plurality of power semiconductor switches or controllable electrical valves can also be connected electrically in parallel with one another, if appropriate.

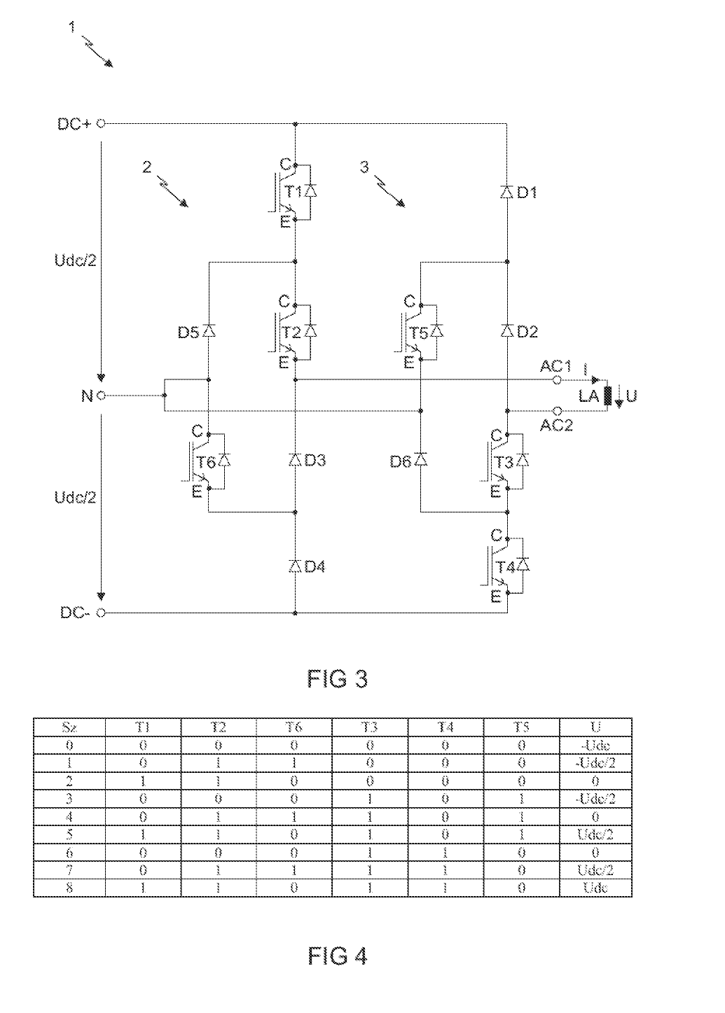

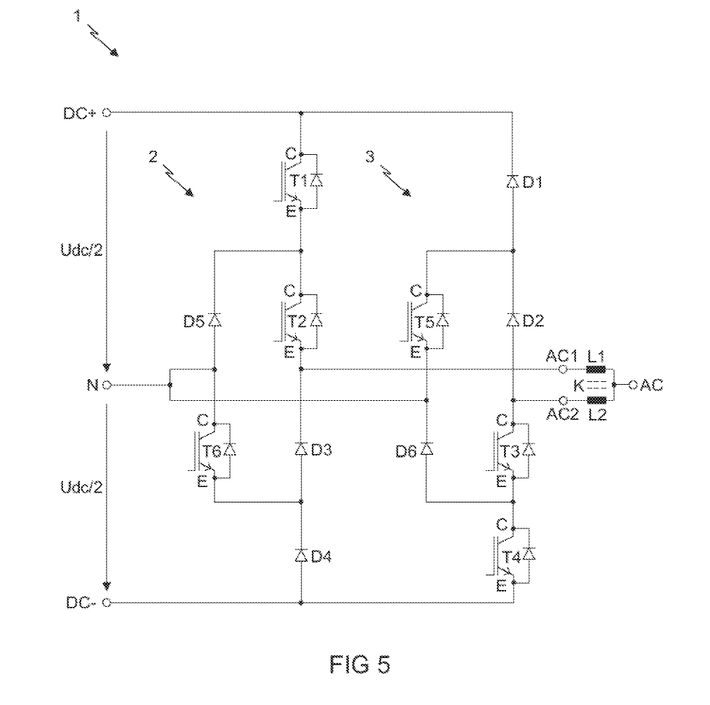

FIG. 3 illustrates an electrical circuit diagram of a circuit arrangement 1 according to the invention. FIG. 4 shows, by way of example, a switching state table of the power converter valves of circuit arrangement 1 according to the invention, wherein other switching state tables are also possible.

The voltage U occurring between first and second AC voltage connections AC1 and AC2 of inventive circuit arrangement 1 is illustrated as a function of the switching states Sz of controllable power converter valves (T1 to T6) in the switching state table. In this case, a “0” means that the power converter valve in question is switched off and a “1” means that the power converter valve in question is switched on. The electrical load LA can be, for example, a winding of a 3-phase reluctance motor, wherein a circuit arrangement 1 assigned to the respective winding is provided for each of the three windings of the 3-phase reluctance motor. The three circuit arrangements 1 together form a multilevel power converter.

Electrical load LA can also be present in the form of a superconducting magnetic energy store (SMES).

Circuit arrangement 1 is fed by two voltage sources (not illustrated in FIG. 3), which each generate half the DC− link voltage Ud/2, so that the DC− link voltage Ud is present between the positive potential voltage connection DC+ and the negative potential voltage connection DC−.

The circuit arrangement has a first circuit branch 2 and a second circuit branch 3, which is connected electrically in parallel with first circuit branch 2, the positive potential voltage connection DC+, the negative potential voltage connection DC−, a neutral connection N and first and second AC voltage connections AC1 and AC2.

First circuit branch 2 has controllable first, second and sixth electrical valves T1, T2 and T6 and third, fourth and fifth diodes D3, D4 and D5. Second circuit branch 3 has controllable third, fourth and fifth electrical valves T3, T4 and T5 and first, second and sixth diodes D1, D2 and D6.

First load current connection C of first electrical valve T1 is electrically conductively connected to the cathode of first diode D1 and to positive potential voltage connection DC+. Second load current connection E of fourth electrical valve T4 is electrically conductively connected to the anode of fourth diode D4 and to negative potential voltage connection DC−. Second load current connection E of first electrical valve T1 is electrically conductively connected to first load current connection C of second electrical valve T2 and to the cathode of fifth diode D5. The anode of first diode D1 is electrically conductively connected to first load current connection C of fifth electrical valve T5 and to the cathode of second diode D2. The anode of fifth diode D5 is electrically conductively connected to neutral connection N and to first load current connection C of sixth electrical valve T6. The anode of second diode D2 is electrically conductively connected to second AC voltage connection AC2 and to first load current connection C of third electrical valve T3. Second load current connection E of second electrical valve T2 is electrically conductively connected to the cathode of third diode D3 and to first AC voltage connection AC1. Second load current connection E of fifth electrical valve T5 is electrically conductively connected to the cathode of sixth diode D6 and to neutral connection N. Second load current connection E of sixth electrical valve T6 is electrically conductively connected to the anode of third diode D3 and to the cathode of fourth diode D4. Second load current connection E of third electrical valve T3 is electrically conductively connected to the anode of sixth diode D6 and to first load current connection C of fourth electrical valve T4.

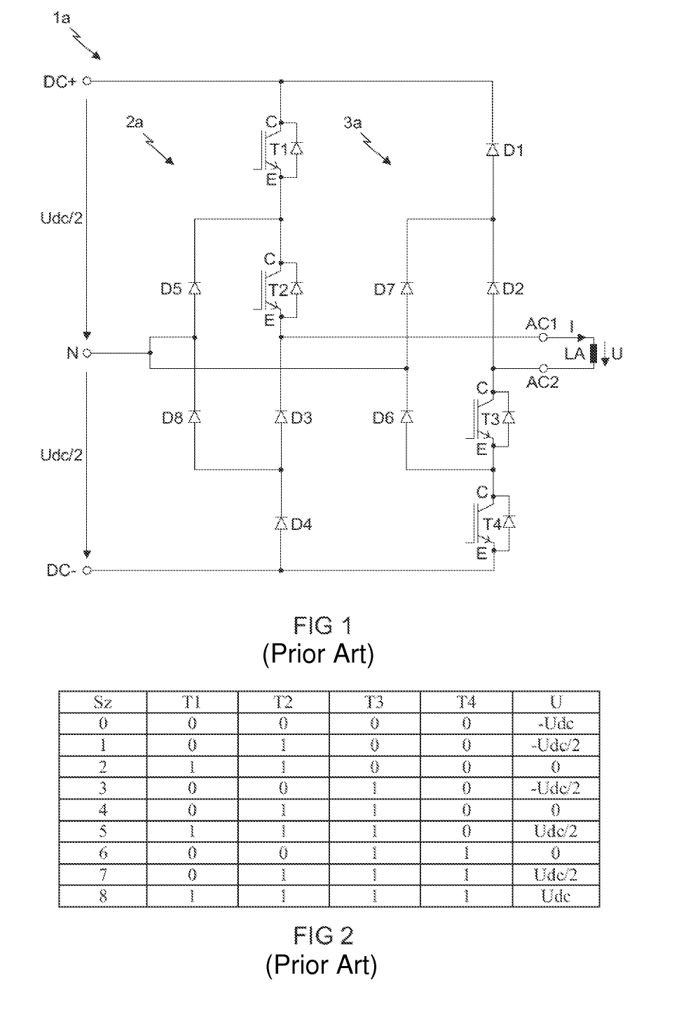

Circuit arrangement 1 according to the invention differs from known circuit arrangement 1a (FIG. 1) in that a power semiconductor switch is connected back-to-back in parallel with the diode D8 so that sixth electrical valve T6 is formed, and in that a power semiconductor switch is connected back-to-back in parallel with the diode D7 so that fifth electrical valve T5 is formed. In the case of the use of MOSFETs as power semiconductor switches, diodes D8 and D7 are replaced by MOSFETs.

The additional sixth electrical valve T6 makes it possible to allow the load current I to flow partially through the switched-on sixth electrical valve T6 in a switching state Sz of circuit arrangement 1 in which load current I flows through fifth diode D5, so that current splitting of load current I between fifth diode D5 and sixth electrical valve T6 takes place. The additional fifth electrical valve T5 makes it possible to allow load current I to flow partially through the switched-on fifth electrical valve T5 in a switching state Sz of circuit arrangement 1 in which load current I is flowing through sixth diode D6, so that current splitting of load current I between sixth diode D6 and fifth electrical valve T5 takes place. As a result, a marked reduction in the power losses of circuit arrangement 1 is achieved. Furthermore, the power losses of circuit arrangement 1 are hereby distributed more uniformly between the power semiconductor components of circuit arrangement 1 (controllable electrical valves, diodes) so that, during operation of circuit arrangement 1, the power semiconductor components of circuit arrangement 1 are heated more uniformly with one another. This results in locally more uniform heating or heat distribution of circuit arrangement 1. The power losses constitute the electrical power which results in heating of the power semiconductor components of circuit arrangement 1.

If circuit arrangement 1 is in switching state 1, for example, load current I flows from neutral connection N via fifth diode D5 and via second electrical valve T2 to load LA and additionally via sixth electrical valve T6 and third diode 3 to load LA and from load LA via second and first diodes D2 and D1 to positive potential voltage connection DC+. If circuit arrangement 1 is in switching state 3, for example, load current I flows from negative potential voltage connection DC− via fourth and third diodes D4 and D3 to load LA and from load LA via third electrical valve T3 and via sixth diode D6 to neutral connection N and additionally via second diode D2 and fifth electrical valve T5 to neutral connection N.

Preferably, circuit arrangement 1 is actuated in such a way that when first, second, third and fourth electrical valves T1, T2, T3 and T4 are switched off, fifth and sixth electrical valves T5 and T6 are switched off and that when second electrical valve T2 is switched on and first, third and fourth electrical valves T1, T3 and T4 are switched off, fifth electrical valve T5 is switched off and sixth electrical valve T6 is switched on, and that when first and second electrical valves T1 and T2 are switched on and third and fourth electrical valves T3 and T4 are switched off, fifth and sixth electrical valves T5 and T6 are switched off, and that when first, second and fourth electrical valves T1, T2 and T4 are switched off and third electrical valve T3 is switched on, fifth electrical valve T5 is switched on and sixth electrical valve T6 is switched off, and that when first and fourth electrical valves T1 and T4 are switched off and second and third electrical valves T2 and T3 are switched on, fifth and sixth electrical valves T5 and T6 are switched on, and that when first, second and third electrical valves T1, T2 and T3 are switched on and fourth electrical valve T4 is switched off, fifth electrical valve T5 is switched on and sixth electrical valve T6 is switched off, and that when first and second electrical valves T1 and T2 are switched off and third and fourth electrical valves T3 and T4 are switched on, fifth and sixth electrical valves T5 and T6 are switched off, and that when second, third and fourth electrical valves T2, T3 and T4 are switched on and first electrical valve T1 is switched off, fifth electrical valve T5 is switched off and sixth electrical valve T6 is switched on, and that when first, second, third and fourth electrical valves T1, T2, T3 and T4 are switched on, fifth and sixth electrical valves T5 and T6 are switched off.

It is of course possible for the controllable electrical valves of circuit arrangement 1 to also be actuated in another way than that described in the paragraph above or in the switching state table shown in FIG. 4 in order to increase the power density of circuit arrangement 1 in the case of pulse-width-modulated actuation (PWM) of the controllable electrical valves of circuit arrangement 1, for example.

Circuit arrangement 1 can have, as illustrated by way of example in FIG. 5, first and second inductances L1 and L2 and a total AC voltage connection AC, wherein first inductance L1 is connected electrically between first AC voltage connection AC1 and the total AC voltage connection AC, wherein second inductance L2 is connected electrically between second AC voltage connection AC2 and total AC voltage connection AC. First and second inductances L1 and L2 are preferably in the form of a winding wound on a magnetizable core (coil with core). As indicated by the reference symbol K in FIG. 5, first and second inductances L1 and L2 can in this case be coupled magnetically to one another (the windings of first and second inductances L1 and L2 are wound onto a common core), wherein first and second inductances L1 and L2 can be magnetically coupled with positive or negative feedback. As a result, optimum matching of circuit arrangement 1 to the specific application is possible.

Circuit arrangement 1 shown in FIG. 5 generally forms one phase of a polyphase multilevel power converter. Total AC voltage connection AC in this case forms the AC voltage connection of one phase of the polyphase multilevel power converter. Three circuit arrangements 1 shown in FIG. 5 form together a 3-phase multilevel power converter.

It is of course also possible for the total AC voltage connections AC of a plurality of circuit arrangements 1 designed as shown in FIG. 5 to be connected in parallel in order to increase the electrical power.

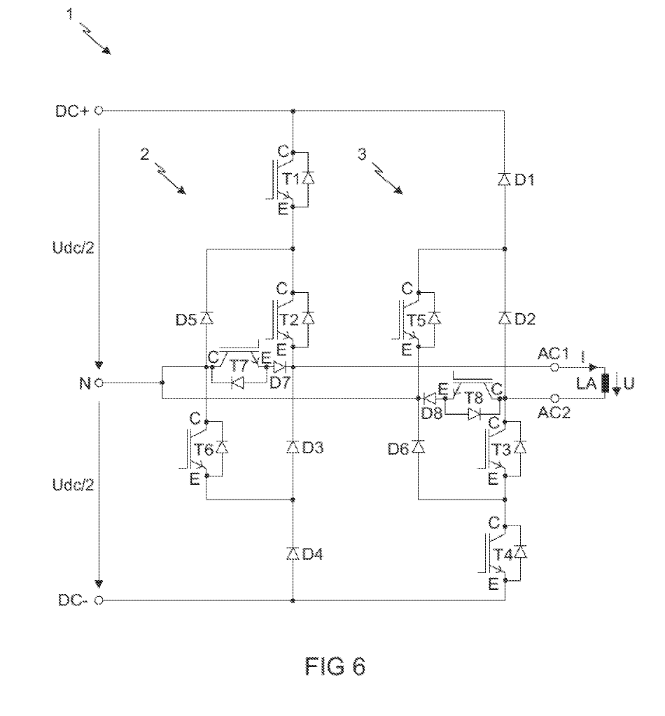

FIG. 6 illustrates an electrical circuit diagram of a further circuit arrangement 1 according to the invention which corresponds to circuit arrangement 1 shown in FIG. 5 apart from the fact that first circuit branch 2 of circuit arrangement 1 shown in FIG. 5 additionally has a controllable seventh electrical valve T7 and a seventh diode D7 and second circuit branch 3 of circuit arrangement 1 shown in FIG. 6 additionally has a controllable eighth electrical valve T8 and a eighth diode D8.

First load current connection C of seventh electrical valve T7 is electrically conductively connected to the anode of fifth diode D5 and second load current connection E of seventh electrical valve T7 is electrically conductively connected to the anode of seventh diode D7 and the cathode of seventh diode D7 is electrically conductively connected to second load current connection E of second electrical valve T2. First load current connection C of eighth electrical valve T8 is electrically conductively connected to the anode of second diode D2 and second load current connection E of eighth electrical valve T8 is electrically conductively connected to the anode of eighth diode D8 and the cathode of eighth diode D8 is electrically conductively connected to second load current connection E of fifth electrical valve T5.

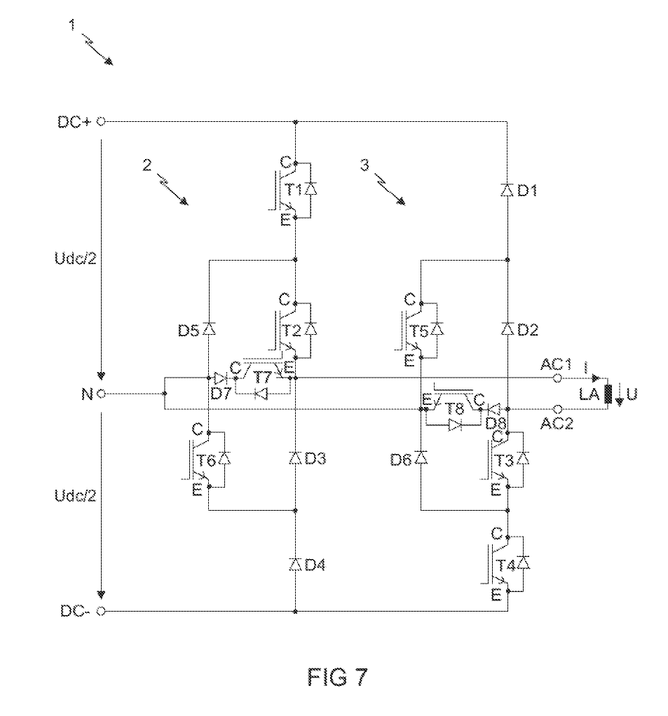

FIG. 7 shows an electrical circuit diagram of a further circuit arrangement 1 according to the invention which corresponds to circuit arrangement 1 shown in FIG. 6 apart from the fact that the positions of seventh electrical valve T7 and seventh diode D7 and the positions of eighth electrical valve T8 and eighth diode D8 have been swapped over. To this extent, first load current connection C of seventh electrical valve T7 is electrically conductively connected to the cathode of seventh diode D7 and second load current connection E of seventh electrical valve T7 is electrically conductively connected to second load current connection E of second electrical valve T2 and the anode of seventh diode D7 is electrically conductively connected to fifth diode D5.

The respective circuit arrangements 1 shown in FIGS. 6 and 7 provide further degrees of freedom. The respective additional electrical series circuit branch consisting of seventh electrical valve T7 and seventh diode D7 or of eighth electrical valve T8 and eighth diode D8 results in a further reduction in the current which flows through fifth diode D5 or through sixth diode D6. The power losses of circuit arrangement 1 can thus be further reduced.

The respective circuit arrangements 1 shown in FIGS. 6 and 7 can of course have, analogously to circuit arrangement 1 shown in FIG. 5, additionally first and second inductances L1 and L2 and total AC voltage connection AC, wherein first and second inductances L1 and L2 and total AC voltage connection AC are interconnected with one another analogously or first and second inductances L1 and L2 can be magnetically coupled to one another analogously. These total AC voltage connections AC can of course also be connected in parallel with one another in order to increase the electric power.

It will be mentioned that preferably first circuit branch 2 of circuit arrangement 1 is realized within a first power semiconductor module and second circuit branch 2 of circuit arrangement 3 is realized within a second power semiconductor module, wherein first and second power semiconductor modules can be electrically connected in parallel with one another in order to realize circuit arrangement 1.

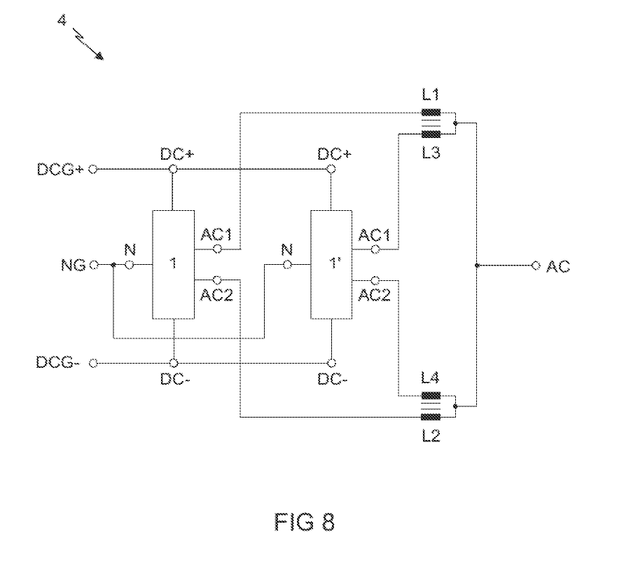

If very high electric powers are required, any desired number of circuit arrangements 1 according to the invention can be interconnected electrically to form a circuit system. Within the scope of the exemplary embodiment shown in FIG. 8, a first circuit arrangement 1 according to the invention and a second circuit arrangement 1′ according to the invention are interconnected electrically in order to realize the circuit system 4. As already described above, circuit system 4 can of course also have, in addition to first and second circuit arrangements according to the invention, circuit arrangements according to the invention which are electrically interconnected analogously to the first and second circuit arrangements according to the invention.

Circuit system 4 has, in addition to first and second circuit arrangements 1 and 1′ according to the invention, first, second, third and fourth inductances L1, L2, L3 and L4 and a total AC voltage connection AC. Positive potential voltage connection DC+ of first circuit arrangement 1 is electrically conductively connected to positive potential voltage connection DC+ of second circuit arrangement 1′ and negative potential voltage connection DC− of first circuit arrangement 1 is electrically conductively connected to negative potential voltage connection DC− of second circuit arrangement 1′. First inductance L1 is connected electrically between first AC voltage connection AC1 of first circuit arrangement 1 and total AC voltage connection AC. Third inductance L3 is connected electrically between first AC voltage connection AC1 of second circuit arrangement 1′ and total AC voltage connection AC. Second inductance L2 is connected electrically between second AC voltage connection AC2 of first circuit arrangement 1 and total AC voltage connection AC. Fourth inductance L4 is connected electrically between second AC voltage connection AC2 of second circuit arrangement 1′ and total AC voltage connection AC. Neutral connection N of first circuit arrangement 1 is electrically conductively connected to neutral connection N of second circuit arrangement 1′. First and third inductances L1 and L3 are coupled magnetically to one another, and second and fourth inductances L2 and L4 are coupled magnetically to one another.

First and third inductances L1 and L3 are coupled magnetically with positive or negative feedback. Furthermore, second and fourth inductances L2 and L4 are coupled magnetically with positive or negative feedback. As a result, optimum matching of the circuit system to the specific application is possible.

It will be mentioned that features of various exemplary embodiments of the invention, insofar as the features are not mutually exclusive, can of course be combined with one another as desired.

Further mention will be made of the fact that neutral connection N can be electrically conductively connected to ground.

In the preceding Detailed Description, reference was made to the accompanying drawings, which form a part of this disclosure, and in which are shown illustrative specific embodiments of the invention. In this regard, directional terminology, such as “top”, “bottom”, “left”, “right”, “front”, “back”, etc., is used with reference to the orientation of the Figure(s) with which such terms are used. Because components of embodiments can be positioned in a number of different orientations, the directional terminology is used for purposes of ease of understanding and illustration only and is not to be considered limiting.

Additionally, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A circuit arrangement comprising:
a first circuit branch;
a second circuit branch, which is electrically connected in parallel with said first circuit branch;
a positive potential voltage connection;
a negative potential voltage connection;
a neutral connection; and
first and second AC voltage connections;
wherein said first circuit branch has controllable first, second and sixth electrical valves and third, fourth and fifth diodes;
wherein said second circuit branch has controllable third, fourth and fifth electrical valves and first, second and sixth diodes;
wherein a first load current connection of said first electrical valve is electrically conductively connected to a cathode of said first diode and to said positive potential voltage connection;
wherein a second load current connection of said fourth electrical valve is electrically conductively connected to an anode of said fourth diode and to said negative potential voltage connection;
wherein a second load current connection of said first electrical valve is electrically conductively connected to a first load current connection of said second electrical valve and a cathode of said fifth diode;
wherein an anode of said first diode is electrically conductively connected to a first load current connection of said fifth electrical valve and a cathode of said second diode;
wherein an anode of said fifth diode is electrically conductively connected to said neutral connection and to a first load current connection of said sixth electrical valve;
wherein an anode of said second diode is electrically conductively connected to said second AC voltage connection and to a first load current connection of said third electrical valve;
wherein a second load current connection of said second electrical valve is electrically conductively connected to a cathode of said third diode and to said first AC voltage connection;
wherein a second load current connection of said fifth electrical valve is electrically conductively connected to a cathode of said sixth diode and to said neutral connection; and
wherein a second load current connection of said sixth electrical valve is electrically conductively connected to an anode of said third diode and to a cathode of said fourth diode; and
wherein a second load current connection of said third electrical valve is electrically conductively connected to an anode of said sixth diode and to a first load current connection of said fourth electrical valve.

2. The circuit arrangement of claim 1,
wherein the circuit arrangement further comprises:
a first inductance;
a second inductance; and
a total AC voltage connection;
wherein said first inductance is electrically connected between said first AC voltage connection and said total AC voltage connection;
wherein said second inductance is electrically connected between said second AC voltage connection and said total AC voltage connection.

3. The circuit arrangement of claim 2, wherein said first and second inductances are magnetically coupled to one another.

4. The circuit arrangement of claim 1,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to an anode of said fifth diode, and a second load current connection of said seventh electrical valve is electrically conductively connected to an anode of said seventh diode, and a cathode of said seventh diode is electrically conductively connected to a second load current connection of said second electrical valve; and
wherein a first load current connection of said eighth electrical valve is electrically conductively connected to an anode of said second diode, and a second load current connection of said eighth electrical valve is electrically conductively connected to an anode of said eighth diode, and a cathode of said eighth diode is electrically conductively connected to a second load current connection of said fifth electrical valve.

5. The circuit arrangement as claimed claim 4,
wherein the circuit arrangement further comprises:
a first inductance;
a second inductance; and
a total AC voltage connection;
wherein said first inductance is electrically connected between said first AC voltage connection and said total AC voltage connection;
wherein said second inductance is electrically connected between said second AC voltage connection and said total AC voltage connection.

6. The circuit arrangement of claim 5, wherein said first and second inductances are magnetically coupled to one another.

7. The circuit arrangement of claim 1,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to an anode of said fifth diode, and a second load current connection of said seventh electrical valve is electrically conductively connected to an anode of said seventh diode, and a cathode of said seventh diode is electrically conductively connected to a second load current connection of said second electrical valve; and
wherein a first load current connection of said eighth electrical valve is electrically conductively connected to a cathode of said eighth diode and a second load current connection of said eighth electrical valve is electrically conductively connected to a second load current connection of said fifth electrical valve and an anode of said eighth diode is electrically conductively connected to an anode of said second diode.

8. The circuit arrangement as claimed claim 7,
wherein the circuit arrangement further comprises:
a first inductance;
a second inductance; and
a total AC voltage connection;
wherein said first inductance is electrically connected between said first AC voltage connection and said total AC voltage connection;
wherein said second inductance is electrically connected between said second AC voltage connection and said total AC voltage connection.

9. The circuit arrangement of claim 8, wherein said first and second inductances are magnetically coupled to one another.

10. The circuit arrangement of claim 1,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to a cathode of said seventh diode and a second load current connection of said seventh electrical valve is electrically conductively connected to a second load current connection of said second electrical valve and an anode of said seventh diode is electrically conductively connected to an anode of said fifth diode; and
wherein a first load current connection of said eighth electrical valve is electrically conductively connected to an anode of said second diode, and a second load current connection of said eighth electrical valve is electrically conductively connected to an anode of said eighth diode, and a cathode of said eighth diode is electrically conductively connected to a second load current connection of said fifth electrical valve.

11. The circuit arrangement as claimed claim 10,
wherein the circuit arrangement further comprises:
a first inductance;
a second inductance; and
a total AC voltage connection;
wherein said first inductance is electrically connected between said first AC voltage connection and said total AC voltage connection;
wherein said second inductance is electrically connected between said second AC voltage connection and said total AC voltage connection.

12. The circuit arrangement of claim 11, wherein said first and second inductances are magnetically coupled to one another.

13. The circuit arrangement of claim 1,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to a cathode of said seventh diode and a second load current connection of said seventh electrical valve is electrically conductively connected to a second load current connection of said second electrical valve and an anode of said seventh diode is electrically conductively connected to an anode of said fifth diode; and
wherein a first load current connection of said eighth electrical valve is electrically conductively connected to a cathode of said eighth diode and a second load current connection of said eighth electrical valve is electrically conductively connected to a second load current connection of said fifth electrical valve and an anode of said eighth diode is electrically conductively connected to an anode of said second diode.

14. The circuit arrangement as claimed claim 13,
wherein the circuit arrangement further comprises:
a first inductance;
a second inductance; and
a total AC voltage connection;
wherein said first inductance is electrically connected between said first AC voltage connection and said total AC voltage connection;
wherein said second inductance is electrically connected between said second AC voltage connection and said total AC voltage connection.

15. The circuit arrangement of claim 14, wherein said first and second inductances are magnetically coupled to one another.

16. A circuit system comprising first and second circuit arrangements, each of said circuit arrangements including:
a first circuit branch;
a second circuit branch, which is electrically connected in parallel with said first circuit branch;
a positive potential voltage connection;
a negative potential voltage connection;
a neutral connection;
first and second AC voltage connections;
first, second, third and fourth inductances; and
a total AC voltage connection;
wherein said first circuit branch has controllable first, second and sixth electrical valves and third, fourth and fifth diodes;
wherein said second circuit branch has controllable third, fourth and fifth electrical valves and first, second and sixth diodes;
wherein a first load current connection of said first electrical valve is electrically conductively connected to a cathode of said first diode and to said positive potential voltage connection;
wherein a second load current connection of said fourth electrical valve is electrically conductively connected to an anode of said fourth diode and to said negative potential voltage connection;
wherein a second load current connection of said first electrical valve is electrically conductively connected to a first load current connection of said second electrical valve and a cathode of said fifth diode;
wherein an anode of said first diode is electrically conductively connected to a first load current connection of said fifth electrical valve and a cathode of said second diode;
wherein an anode of said fifth diode is electrically conductively connected to said neutral connection and to a first load current connection of said sixth electrical valve;
wherein an anode of said second diode is electrically conductively connected to said second AC voltage connection and to a first load current connection of said third electrical valve;
wherein a second load current connection of said second electrical valve is electrically conductively connected to a cathode of said third diode and to said first AC voltage connection;
wherein a second load current connection of said fifth electrical valve is electrically conductively connected to a cathode of said sixth diode and to said neutral connection;
wherein a second load current connection of said sixth electrical valve is electrically conductively connected to an anode of said third diode and to a cathode of said fourth diode;
wherein a second load current connection of said third electrical valve is electrically conductively connected to an anode of said sixth diode and to a first load current connection of said fourth electrical valve;
wherein said positive potential voltage connection of said first circuit arrangement is electrically conductively connected to said positive potential voltage connection of said second circuit arrangement, and said negative potential voltage connection of said first circuit arrangement is electrically conductively connected to said negative potential voltage connection of said second circuit arrangement;
wherein said first inductance is electrically connected between said first AC voltage connection of said first circuit arrangement and said total AC voltage connection;
wherein said third inductance is electrically connected between said first AC voltage connection of said second circuit arrangement and said total AC voltage connection;
wherein said second inductance is electrically connected between said second AC voltage connection of said first circuit arrangement and said total AC voltage connection;
wherein said fourth inductance is electrically connected between said second AC voltage connection of said second circuit arrangement and said total AC voltage connection;
wherein said neutral connection of said first circuit arrangement is electrically conductively connected to said neutral connection of said second circuit arrangement; and
wherein said first and third inductances are coupled magnetically to one another, and said second and fourth inductances are coupled magnetically to one another.

17. The circuit system of claim 16,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to an anode of said fifth diode, and a second load current connection of said seventh electrical valve is electrically conductively connected to an anode of said seventh diode, and a cathode of said seventh diode is electrically conductively connected to a second load current connection of said second electrical valve; and
wherein a first load current connection of said eighth electrical valve is electrically conductively connected to an anode of said second diode, and a second load current connection of said eighth electrical valve is electrically conductively connected to an anode of said eighth diode, and a cathode of said eighth diode is electrically conductively connected to a second load current connection of said fifth electrical valve.

18. The circuit system of claim 16,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to an anode of said fifth diode, and a second load current connection of said seventh electrical valve is electrically conductively connected to an anode of said seventh diode, and a cathode of said seventh diode is electrically conductively connected to a second load current connection of said second electrical valve; and
wherein a first load current connection of said eighth electrical valve is electrically conductively connected to a cathode of said eighth diode and a second load current connection of said eighth electrical valve is electrically conductively connected to a second load current connection of said fifth electrical valve and an anode of said eighth diode is electrically conductively connected to an anode of said second diode.

19. The circuit system of claim 16,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to a cathode of said seventh diode and a second load current connection of said seventh electrical valve is electrically conductively connected to a second load current connection of said second electrical valve and an anode of said seventh diode is electrically conductively connected to an anode of said fifth diode; and
wherein a first load current connection of said eighth electrical valve is electrically conductively connected to an anode of said second diode, and a second load current connection of said eighth electrical valve is electrically conductively connected to an anode of said eighth diode, and a cathode of said eighth diode is electrically conductively connected to a second load current connection of said fifth electrical valve.

20. The circuit system of claim 16,
wherein said first circuit branch has a controllable seventh electrical valve and a seventh diode, and said second circuit branch has a controllable eighth electrical valve and an eighth diode;
wherein a first load current connection of said seventh electrical valve is electrically conductively connected to a cathode of said seventh diode and a second load current connection of said seventh electrical valve is electrically conductively connected to a second load current connection of said second electrical valve and an anode of said seventh diode is electrically conductively connected to an anode of said fifth diode; and
wherein a first load current connection of said eighth electrical valve is electrically conductively connected to a cathode of said eighth diode and a second load current connection of said eighth electrical valve is electrically conductively connected to a second load current connection of said fifth electrical valve and an anode of said eighth diode is electrically conductively connected to an anode of said second diode.
